(19) United States
(12) Patent Application Publication
(10) Pub. No.: US 2012/0061863 A1
(43) Pub. Date: Mar. 15, 2012

(54) MOLD FOR DIFFRACTIVE OPHTHALMIC LENS

(75) Inventors: Bryan Cox, Braselton, GA (US); Youval Katzman, Kibbutz Shamir (IL); Yassin Turshani, Madeira Beach, FL (US); Anita Trajkovska, Christiansburg, VA (US); Venkatramani Iyer, Roanoke, VA (US); David Strickland, Blue Ridge, VA (US)

(73) Assignee: PIXELOPTICS, INC., Roanoke, VA (US)

(21) Appl. No.: 13/180,025

(22) Filed: Jul. 11, 2011

Related U.S. Application Data
(60) Provisional application No. 61/362,772, filed on Jul. 9, 2010.
(60) Provisional application No. 61/415,937, filed on Nov. 22, 2010.

(51) Int. Cl. B29C 59/02; B29D 11/00

(52) U.S. Cl. 264/1.7; 425/385

(57) ABSTRACT

An apparatus for molding at least one side of an ophthalmic diffractive lens. The apparatus includes a first mold, wherein the first mold includes at least a first portion made of plastic, and wherein the first portion includes a first pattern on a surface thereof, the first pattern configured to impart a diffractive optical pattern on a surface on the at lest one side of the ophthalmic diffractive lens molded using the first mold.

### CROSS-REFERENCES TO RELATED APPLICATIONS

This application claims priority benefit of U.S. provisional patent application No. 61/362,772, filed on Jul. 9, 2010, and U.S. provisional patent application No. 61/415,937, filed on Nov. 22, 2010, the entire disclosure of these applications being incorporated herein by reference for all purposes and in its entirety.

### BACKGROUND

Diffractive ophthalmic lenses can be formed using molds. However, conventional glass molds are generally not suitable for the production of diffractive ophthalmic lenses. Specifically, the diamond turning or free forming processes, which are used to produce a negative diffractive optical pattern generally cannot achieve the desired fidelity of the diffractive pattern on a glass mold. Hot embossing of a glass mold to obtain the negative diffractive optical pattern is also not generally feasible as the transition temperature of glass can exceeds the limits of today's technology for hot embossing the negative diffractive pattern onto glass molds. Consequently, electro-formed nickel molds are typically used in the fabrication of diffractive ophthalmic lenses.

Electro-formed nickel molds can suffer from a number of drawbacks. Such drawbacks include, but are not limited to, the costliness of fabrication and/or the requirement of special coatings to protect the nickel surface from oxidizing. Regarding this latter drawback, chrome coating can be a low cost choice but can require special legal permits due to its perceived adverse environmental effects. Further, evaporative coatings used during the fabrication of electro-formed nickel molds are often cost prohibitive, and electro-formed nickel molds can only be supplied by a limited number of providers for the ophthalmic industry. Still further, such molds require a cleaning process after each use of the mold that can degrade the fidelity of the negative diffractive pattern on the mold. Inadequate cleaning can leave behind casting debris that can degrade the performance of the diffractive region.

Overall, these factors can cause the fabrication of diffractive ophthalmic lenses—or any lens having a diffractive pattern—to be prohibitively expensive.

### BRIEF SUMMARY

In an exemplary embodiment, there is an apparatus for molding at least one side of a diffractive ophthalmic lens, comprising a first mold, wherein the first mold includes at least a first portion made of plastic, and wherein the first portion includes a first pattern on a surface thereof, the first pattern configured to impart a diffractive optical pattern on a surface on the at lest one side of the diffractive ophthalmic lens molded using the first mold. In an exemplary embodiment, there is an apparatus as described above and/or below, wherein the first mold includes a second portion, wherein the first portion is a separate component from the second portion, wherein the second portion includes a surface that is configured to impart a non-diffractive optical feature on the at least the one side of the diffractive ophthalmic lens molded using the first mold. In an exemplary embodiment, there is an apparatus as described above and/or below, wherein the non-diffractive optical feature is a refractive optical surface. In an exemplary embodiment, there is an apparatus as described above and/or below, wherein the first portion is connected to and held to the second portion via an interference fit. In an exemplary embodiment, there is an apparatus as described above and/or below, the first portion is connected to the second portion via positive retention. In an exemplary embodiment, there is an apparatus as described above and/or below, wherein the first portion is connected to the second portion via an adhesive bond.

In an exemplary embodiment, there is an apparatus as described above and/or below, the first portion corresponds to a male portion, and the second portion corresponds to a female portion, and wherein the first portion and the second portion are located relative to one another in a male-female relationship. In an exemplary embodiment, there is an apparatus as described above and/or below, wherein the first portion and second portion are made of plastic. In an exemplary embodiment, there is an apparatus as described above and/or below, wherein the second portion is made of glass. In an exemplary embodiment, there is an apparatus as described above and/or below, wherein the non-diffractive optical feature is a refractive optical surface, and wherein the first and second portions are collectively configured to mold the entire at least one side of the diffractive ophthalmic lens, thereby defining a surface of the lens having both diffractive optical properties and refractive optical properties at locations on the lens surface immediately adjacent to the first and second portions, respectively. In an exemplary embodiment, there is an apparatus as described above and/or below, wherein the second portion is further configured to impart another non-diffractive optical feature different from the refractive optical surface on the at least the one side of the diffractive ophthalmic lens molded using the first mold. In an exemplary embodiment, there is an apparatus as described above and/or below, wherein the first portion and the second portions include respective working surfaces configured to impart the respective optical features on the at least the one side of the diffractive ophthalmic lens molded using the first mold, wherein the working surface of the second portion has at least about five times the surface area of the working surface of the first portion. In an exemplary embodiment, there is an apparatus as described above and/or below, wherein the first mold is a monolithic component.

In an exemplary embodiment, there is an apparatus as described above and/or below, wherein the first mold includes a second portion, wherein the first portion and the second portion form at least a portion of the monolithic component, and wherein the second portion includes a surface that is configured to impart a non-diffractive optical feature on the at least the one side of the diffractive ophthalmic lens molded using the first mold. In an exemplary embodiment, there is an apparatus as described above and/or below, wherein the non-diffractive optical feature is a refractive optical surface. In an exemplary embodiment, there is an apparatus as described above and/or below, wherein the first portion is made of plastic. In an exemplary embodiment, there is an apparatus as described above and/or below, wherein the first mold includes a second portion, wherein the first portion is a separate component from the second portion, wherein the second portion is a substrate that supports the first portion, and wherein the first portion is at least part of a liner lining a surface of the second portion. In an exemplary embodiment, there is an apparatus as described above and/or below, wherein the second portion is made of glass and/or metal, and wherein the first portion adheres to the second portion. In an exemplary embodiment, there is an apparatus as described above and/or below, wherein the first mold includes a third portion, wherein the third portion is configured to impart a non-diffractive optical feature on the at least the one side of the diffractive ophthalmic lens molded using the first mold, wherein the liner comprises the first portion and the third portion. In an exemplary embodiment, there is an apparatus as described above and/or below, wherein the first portion is adhered to the second portion via an adhesive.

In an exemplary embodiment, there is an apparatus for molding at least one side of a diffractive ophthalmic lens, comprising a first mold, wherein the first mold includes at least a first portion that includes a first pattern on a surface thereof, the first pattern configured to impart a diffractive optical pattern on a surface of the at lest one side of the diffractive ophthalmic lens molded using the first mold, and a second portion, wherein the first portion is a separate component from the second portion, wherein the second portion includes a surface that is configured to impart a non-diffractive optical feature on the at least one side of the diffractive ophthalmic lens molded using the first mold. In an exemplary embodiment, there is an apparatus as described above and/or below, wherein the first portion is separable from the second portion. In an exemplary embodiment, there is an apparatus as described above and/or below, wherein the first portion is connected to and held to the second portion via an interference fit. In an exemplary embodiment, there is an apparatus as described above and/or below, wherein the first portion is connected to the second portion via positive retention. In an exemplary embodiment, there is an apparatus as described above and/or below, wherein the first portion is connected to the second portion via an adhesive bond. In an exemplary embodiment, there is an apparatus as described above and/or below, wherein the first portion corresponds to a male portion, and the second portion corresponds to a female portion, and wherein the first portion and the second portion are located relative to one another in a male-female relationship.

In an exemplary embodiment, there is an apparatus as described above and/or below, wherein the non-diffractive optical feature is a refractive optical surface, and wherein the first and second portions are collectively configured to mold the entire at least one side of the diffractive ophthalmic lens, thereby defining a surface of the lens having both diffractive optical properties and refractive optical properties at locations on the lens surface immediately adjacent to the first and second portions, respectively. In an exemplary embodiment, there is an apparatus as described above and/or below, wherein the second portion is further configured to impart another non-diffractive optical feature different from the refractive optical surface on the at least the one side of the diffractive ophthalmic lens molded using the first mold. In an exemplary embodiment, there is an apparatus as described above and/or below, wherein the first portion includes a layer of release agent.

In an exemplary embodiment, there is a method of molding an ophthalmic diffractive lenses, comprising (a) obtaining a mold apparatus, wherein the mold apparatus includes at least a first portion that includes a first pattern on a surface thereof and (b) molding at least one first ophthalmic diffractive lenses using the obtained mold apparatus, wherein the action of molding the first diffractive ophthalmic lens includes imparting a diffractive optical pattern on a surface of the first molded ophthalmic diffractive lens from the pattern on the first portion, (c) removing the first portion from the mold apparatus, (d) installing a second portion to the mold apparatus in a location corresponding to a previous position of the first portion, wherein the second portion includes a second pattern on a surface thereof, and (e) molding one or more second ophthalmic diffractive lenses using the obtained mold apparatus as modified with the second portion, wherein the action of molding the second ophthalmic diffractive lens include imparting a diffractive optical pattern on a surface of the second molded ophthalmic diffractive lens from the pattern on the second portion.

In an exemplary embodiment, there is a method as described above and/or below, further comprising molding only about 10 or less first ophthalmic diffractive lenses before proceeding from action “c” to action “d”. In an exemplary embodiment, there is a method as described above and/or below, further comprising molding only 1 first ophthalmic diffractive lens before proceeding from action “c” to action “d”. In an exemplary embodiment, there is a method as described above and/or below, further comprising molding only about 10 or less second ophthalmic diffractive lenses during action “e”, and after completing action “e”, (f) removing the second portion from the mold, (g) installing a first portion on the mold in a location corresponding to a previous position of the second portion, wherein the first portion installed in action “g” is a different component from that of the first portion of action “a” and (h) molding one or more first ophthalmic diffractive lens using the mold apparatus as modified in action “g,” wherein one or more first ophthalmic diffractive lenses are different from those molded in action “b,” wherein the action of molding the first ophthalmic diffractive lens includes imparting a diffractive optical pattern on a surface of the first molded ophthalmic diffractive lens from the pattern on the first portion.

In an exemplary embodiment, there is a method as described above and/or below, further comprising (i) after executing action “h,” executing actions “c,” “d” and “e” followed by executing actions “f,” “g,” and “h,” wherein the second portion installed in action “d” is a different component from that of the second portion installed in action “i,” and (j) repeating action “i” five times. In an exemplary embodiment, there is a method as described above and/or below, wherein the mold apparatus includes a mold that has a portion that is the same portion used to mold a surface of the lenses molded in actions “a” to “j”. In an exemplary embodiment, there is a method as described above and/or below, wherein no action of cleaning the first portion is performed between molding individual first diffractive ophthalmic lenses during action “b” and between molding individual second diffractive ophthalmic lenses during action “e.”

In an exemplary embodiment, there is a method of manufacturing an apparatus for molding at least one side of a diffractive ophthalmic lens, comprising obtaining a mold assembly including a cavity having a first pattern on a surface thereof, adding plastic material into the cavity, and allowing the plastic material to cure such that an outer surface contours to the shape of the surface of the cavity such that a negative of the first pattern is transferred to the cured plastic material, wherein the cured plastic material is in the form of a front mold or a portion of a front mold, and wherein the negative of the first pattern on the surface of the cured plastic material is configured to impart a diffractive optical pattern on a surface on the at least one side of the diffractive ophthalmic lens molded using the first mold. In an exemplary embodiment of this method, the method further comprises positioning cured plastic material in the form of a front mold or a portion of a front mold proximate a glass or metal mold, and attaching the cured plastic material and the glass or metal mold together such that a cavity is formed between the two. In an exemplary embodiment of this method, the action of adding plastic material into the cavity and allowing the plastic material to cure is executed via an injection molding process and/or applying a layer of release agent to the surface of the cured plastic material on which the negative of the first pattern is located.

### BRIEF DESCRIPTION OF THE DRAWINGS

FIG. 1 depicts an isometric view of an exemplary embodiment of an apparatus.

FIG. 2 shows a cross-sectional view of the apparatus of FIG. 1.

FIG. 3 shows a cross-sectional view of an alternative configuration of the apparatus of FIG. 1.

FIG. 3a depicts a schematic of an exemplary diffractive ophthalmic lens manufacturable utilizing the apparatus of FIG. 1.

FIG. 3b depicts an exemplary diffractive ophthalmic lens manufacturable utilizing the apparatus of FIG. 1 depicting performance capabilities.

FIG. 4 shows an alternative configuration of a component usable in the apparatus of FIG. 1.

FIG. 5 shows yet another an alternative configuration of a component usable in the apparatus of FIG. 1.

FIG. 6 shows yet another an alternative configuration of a component usable in the apparatus of FIG. 1.

FIG. 7 shows yet another an alternative configuration of a component usable in the apparatus of FIG. 1.

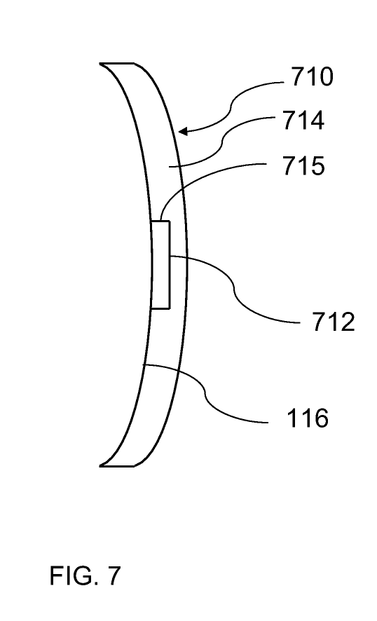

FIG. 8 shows yet another an alternative configuration of a component usable in the apparatus of FIG. 1.

### DETAILED DESCRIPTION OF THE INVENTION

In an exemplary embodiment, there is a mold apparatus for molding a diffractive ophthalmic lens. The mold apparatus comprises a front mold including at least a portion that is made from plastic having a pattern on a surface thereof. This pattern is configured to impart a diffractive optical pattern on a surface on the diffractive ophthalmic lens molded using the front mold. Because the portion is made from plastic and can be made, along with the pattern, by injection molding, it is relatively inexpensive to manufacture. This means that in some embodiments, the portion may be removed from the mold apparatus and replaced with a new portion after one or more moldings, thereby reducing and/or eliminating post-molding cleaning that would be necessary for a portion that is intended to be used many times. Also, such a portion permits a lens manufacturer to obtain more mold apparatus for the same cost as traditional mold apparatuses, thereby permitting the lens manufacturer to increase production.

Add Power: The optical power added to the far distance viewing optical power which is required for clear near distance viewing in a multifocal lens. For example, if an individual has a far distance viewing prescription of −3.00 D with a +2.00 D add power for near distance viewing then the actual optical power in the near distance portion of the multifocal lens is −1.00 D. Add power is sometimes referred to as plus power. Add power may be further distinguished by referring to “near viewing distance add power” which refers to the add power in the near viewing distance portion of the lens and “intermediate viewing distance add power” which refers to the add power in the intermediate viewing distance portion of the lens. Typically, the intermediate viewing distance add power is approximately 50% of the near viewing distance add power. Thus, in the example above, the individual would have +1.00 D add power for intermediate distance viewing and the actual total optical power in the intermediate viewing distance portion of the multifocal lens is −2.00 D.

Approximately: Plus or minus 10 percent, inclusive. Thus, the phrase “approximately 10 mm” may be understood to mean from 9 mm to 11 mm, inclusive.

Blend Zone: An optical power transition along a peripheral edge of a lens whereby the optical power continuously transitions across the blend zone from a first corrective power, to that of a second corrective power or vice versa. Generally the blend zone is designed to have as small a width as possible. A peripheral edge of a dynamic optic may include a blend zone so as to reduce the visibility of the dynamic optic. A blend zone is utilized for cosmetic enhancement reasons and also to enhance vision functionality. A blend zone is typically not considered a usable portion of the lens due to its high unwanted astigmatism. A blend zone is also known as a transition zone.

Contour Maps: Plots that are generated from measuring and plotting the unwanted astigmatic optical power of a Progressive Addition Lens. The contour plot can be generated with various sensitivities of astigmatic optical power thus providing a visual picture of where and to what extent a Progressive Addition Lens possesses unwanted astigmatism as part of its optical design. Analysis of such maps is typically used to quantify the channel length, channel width, reading width and far distance width of a PAL. Contour maps may also be referred to as unwanted astigmatic power maps. These maps can also be used to measure and portray optical power in various parts of the lens.

Conventional Channel Length: Due to aesthetic concerns or trends in eyewear fashion, it may be desirable to have a lens that is foreshortened vertically. In such a lens the channel is naturally also shorter Conventional channel length refers to the length of a channel in a non-foreshortened PAL lens. These channel lengths are usually, but not always, approximately 15 mm or longer. Generally, a longer channel length means a wider channel width and less unwanted astigmatism. Longer channel designs are often associated with “soft” progressives, since the transition between far distance correction and near distance correction is softer due to the more gradual increase in optical power.

Dynamic lens: A lens with an optical power which is alterable with the application of electrical energy, mechanical energy or force. Either the entire lens may have an alterable optical power, or only a portion, region or zone of the lens may have an alterable optical power. The optical power of such a lens is dynamic or tunable such that the optical power can be switched between two or more optical powers. The switching may comprise a discrete change from one optical power to another (such as going from an “off” or inactive state to an “on” or active state) or it may comprise continuous change from a first optical power to a second optical power, such as by varying the amount of electrical energy to a dynamic element. One of the optical powers may be that of substantially no optical power. Examples of dynamic lenses include electro-active lenses, meniscus lenses, fluid lenses, movable dynamic optics having one or more components, gas lenses, and membrane lenses having a member capable of being deformed. A dynamic lens may also be referred to as a dynamic optic, a dynamic optical element, a dynamic optical zone, dynamic power zone, or a dynamic optical region.

Far Distance Reference Point: A reference point located approximately 3-4 mm above the fitting cross where the far distance prescription or far, distance optical power of the lens can be measured easily.

Far Distance Viewing Zone: The portion of a lens containing an optical power which allows a user to see correctly at a far viewing distance.

Far Distance Width: The narrowest horizontal width within the far distance viewing portion of the lens which provides clear, mostly distortion-face correction with an optical power within 0.25 D of the wearer's far distance viewing optical power correction.

Far Viewing Distance: The distance to which one looks, by way of example only, when viewing beyond the edge of one's desk, when driving a car, when looking at a distant mountain, or when watching a movie. This distance is usually, but not always, considered to be approximately 32 inches or greater from the eye the far viewing distance may also be referred to as a far distance and a far distance point.

Fitting Cross/Fitting Point: A reference point on a PAL that represents the approximate location of the wearer's pupil when looking straight ahead through the lens once the lens is mounted in an eyeglass frame and positioned on the wearer's face. The fitting cross/fitting point is usually, but not always, located 2-5 mm vertically above the start of the channel. The fitting cross typically has a very slight amount of plus optical power ranging from just over +0.00 Diopters to approximately +0.12 Diopters. This point or cross is marked on the lens surface such that it can provide an easy reference point for measuring and/or double-checking the fitting of the lens relative to the pupil of the wearer. The mark is easily removed upon the dispensing of the lens to the patient/wearer.

Hard Progressive Addition Lens: A Progressive Addition Lens with a less gradual, steeper transition between the far distance correction and the near distance correction. In a hard PAL the unwanted distortion may be below the fitting point and not spread out into the periphery of the lens. A hard PAL may also have a shorter channel length and a narrower channel width. A “modified hard Progressive Addition Lens” is a hard PAL which is modified to have a limited number of characteristics of a soft PAL such as a more gradual optical power transition, a longer, channel, a wider channel, more unwanted astigmatism spread out into the periphery of the lens, and less unwanted astigmatism below the fitting point.

Intermediate Distance Viewing Zone: The portion of a lens containing an optical power which allows a user to see correctly at an intermediate viewing distance.

Intermediate Viewing Distance: The distance to which one looks, by way of example only, when reading a newspaper, when working on a computer, when washing dishes in a sink, or when ironing clothing. This distance is usually, but not always, considered to be between approximately 16 inches and approximately 32 inches from the eye. The intermediate viewing distance may also be referred to as an intermediate distance and an intermediate distance point.

Lens: Any device or portion of a device that causes light to converge or diverge. The device may be static or dynamic. A lens may be refractive or diffractive. A lens may be either concave, convex or piano on one or both surfaces. A lens may be spherical, cylindrical, prismatic or a combination thereof. A lens may be made of optical glass, plastic or resin. A lens may also be referred to as an optical element, an optical zone, an optical region, an optical power region or an optic. It should be pointed out that within the optical industry a lens can be referred to as a lens even if it has zero optical power.

Lens Blank: A device made of optical material that may be shaped into a lens. A lens blank may be finished meaning that the lens blank has been shaped to have an optical power on both external surfaces. A lens blank may be semi-finished meaning that the lens blank has been shaped to have an optical power on only one external surface. A lens blank may be unfinished meaning that the lens blank has not been shaped to have an optical power on either external surface. A surface of an unfinished or semi-finished lens blank may be finished by means of a fabrication process known as free-forming or by more traditional surfacing and polishing.

Low Add Power PAL: A Progressive Addition Lens that has less than the necessary near add power for the wearer to see clearly at a near distance.

Multifocal Lens: A lens having more than one focal point or optical power. Such lenses may be static or dynamic. Examples of static multifocal lenses include a bifocal lens, trifocal lens or a Progressive Addition Lens. Examples of dynamic multifocal lenses include electro-active lenses whereby various optical powers may be created in the lens depending on the types of electrodes used, voltages applied to the electrodes and index of refraction altered within a thin layer of liquid crystal. Multifocal lenses may also be a combination of static and dynamic. For example, an electro-active element may be used in optical communication with a static spherical lens, static single vision lens, static multifocal lens such as, by way of example only, a Progressive Addition Lens. In most, but not all, cases, multifocal lenses are refractive lenses.

Near Distance Viewing Zone: The portion of a lens containing an optical power which allows a user to see correctly at a near viewing distance.

Near Viewing Distance: The distance to which one looks, by way of example only, when reading a book, when threading a needle, or when reading instructions on a pill bottle. This distance is usually, but not always, considered to be between approximately 12 inches and approximately 16 inches from the eye. The near viewing distance may also be referred to as a near distance and a near distance point.

Office Lens/Office PAL: A specially designed Progressive Addition Lens that provides intermediate distance vision above the fitting cross, a wider channel width and also a wider reading width. This is accomplished by means of an optical design which spreads the unwanted astigmatism above the fitting cross and which replaces the far distance vision zone with that of a mostly intermediate distance vision zone. Because of these features, this type of PAL is well-suited for desk work, but one cannot drive his or her cat or use it for walking around the office or home since the lens contains no far distance viewing area.

Ophthalmic Lens: A lens suitable for vision correction which includes a spectacle lens, a contact lens, an intra-ocular lens, a corneal in-lay, and a corneal on-lay.

Optical Communication: The condition whereby two or more optics of given optical power are aligned in a manner such that light passing through the aligned optics experiences a combined optical power equal to the sum of the optical powers of the individual elements.

Optical Power Stop: A lens component or surface that serves as a “stop” or boundary that will not allow a desired optical power to be exceeded or, in the case of a minimum optical power, the optical stop will prevent the optical power from going below that value. That is, in a dynamic lens, the optical power stop may define the maximum or minimum amount of positive (or negative) optical power. This may comprises a rigid lens component or a surface thereof. As used herein, the term “curvature template” refers to a curvature of a surface of a lens component to which a flexible element (e.g. a membrane) may conform to. Such curvature may define an optical power stop, and therefore provide the precise curvature needed for an optical power.

Patterned Electrodes: Electrodes utilized in an electro-active lens such that with the application of appropriate voltages to the electrodes, the optical power created by the liquid crystal is created diffractively regardless of the size, shape, and arrangement of the electrodes. For example, a diffractive optical effect can be dynamically produced within the liquid crystal by using concentric ring shaped electrodes.

Pixilated Electrodes: Electrodes utilized in an electro-active lens that are individually addressable regardless of the size, shape, and arrangement of the electrodes. Furthermore, because the electrodes are individually addressable, any arbitrary pattern of voltages may be applied to the electrodes. For example, pixilated electrodes may be squares or rectangles arranged in a Cartesian array or hexagons arranged in a hexagonal array. Pixilated electrodes need not be regular shapes that fit to a grid. For example, pixilated electrodes maybe concentric rings if every ring is individually addressable. Concentric pixilated electrodes can be individually addressed to create a diffractive optical effect.

Progressive Addition Region: A region of a lens having a first optical power in a first portion of the region and a second optical power in a second portion of the region wherein a continuous change in optical power exists there between. For example, a region of a lens may have a far viewing distance optical power at one end of the region. The optical power may continuously increase in plus power across the region, to an intermediate viewing distance optical power and then to a near viewing distance optical power at the opposite end of the region. After the optical power has reached a near-viewing distance optical power, the optical power, may decrease in such a way that the optical power of this progressive addition region transitions back into the far viewing distance optical power. A progressive addition region may be on a surface of a lens or embedded within a lens. When a progressive addition region is on the surface and comprises a surface topography it is known as a progressive addition surface.

Reading Width: The narrowest horizontal width within the near distance viewing portion of the lens which provides clear, mostly distortion free correction with an optical power within 0.25 D of the wearer's near distance viewing optical power correction.

Short Channel Length: Due to aesthetic concerns or trends in eyewear fashion, it may be desirable to have a lens that is foreshortened vertically. In such a lens the channel is naturally also shorter. Short channel length refers to the length of a channel in a foreshortened PAL lens. These channel lengths are usually, but not always between approximately 11 mm and approximately 15 mm. Generally, a shorter channel length means a narrower channel width and more unwanted astigmatism. Shorter channel designs are often associated with “hard” progressives, since the transition between far distance correction and near distance correction is harder due to the steeper increase in optical power.

Soft Progressive Addition Lens: A Progressive Addition Lens with a more gradual transition between the far distance correction and the neat distance correction. In a soft PAL the unwanted distortion may be above the fitting point and spread out into the periphery of the lens. A soft PAL may also have a longer channel length and a wider channel width. A “modified soft Progressive Addition Lens” is a soft PAL which is modified to have a limited number of characteristics of a hard PAL such as a steeper optical power transition, a shorter channel, a narrower channel, more unwanted astigmatism pushed into the viewing portion of the lens, and more unwanted astigmatism below the fitting point.

Static Lens: A lens having an optical power which is not alterable with the application of electrical energy, mechanical energy or force. Examples of static lenses include spherical lenses, cylindrical lenses, Progressive Addition Lenses, bifocals, and trifocals. A static lens may also be referred to as a fixed lens. A lens may comprise a portion that is static, which may be referred to as a static power zone, segment, or region.

Unwanted Astigmatism: Unwanted aberrations, distortions or astigmatism found within a Progressive Addition Lens that are not part of the patient's prescribed vision correction, but rather are inherent in the optical design of a PAL due to the smooth gradient of optical power between the viewing zones. Although, a lens may have unwanted astigmatism across different areas of the lens of various dioptric powers, the unwanted astigmatism in the lens generally refers to the maximum unwanted astigmatism that is found in the lens. Unwanted astigmatism may also refer to the unwanted astigmatism located within a specific portion of a lens as opposed to the lens as a whole. In such a case qualifying language is used to indicate that only the unwanted astigmatism within the specific portion of the lens is being considered.

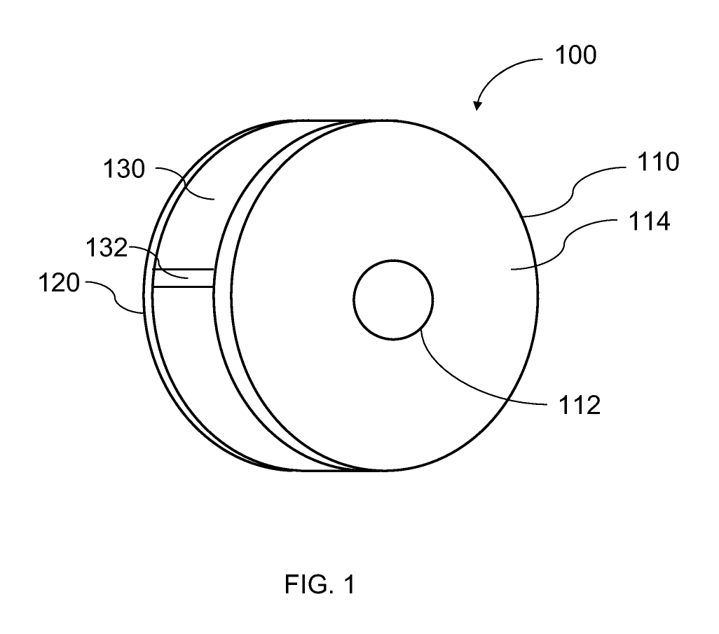

In an exemplary embodiment, referring to FIG. 1, there is an apparatus 100 for molding an ophthalmic lens. The apparatus includes, by way of example, a front mold (first mold) 110 and a back mold (second mold) 120. In an exemplary embodiment, the apparatus 100 in general and the front mold 110 in particular may be used to used to form a diffractive ophthalmic lens. The terms front and back refer to the intended use of the mold components to form a front and back surface of a diffractive ophthalmic lens, where the front surface is the surface further from the eye during use, and the back surface is the surface closer to the eye during use (although, as detailed below, the resulting lens may be further finished, especially with respect to the back surface). The front mold and the back mold are connected via a gasket or tape 130 with an orifice 132 positioned therein, which may be formed by the ends of the gasket or tape 130 not meeting each other. The orifice 132 permits pre-solidified plastic lens material to be inserted between the front mold and the back mold so that a plastic lens may be molded from the pre-solidified plastic lens material, as will be detailed below.

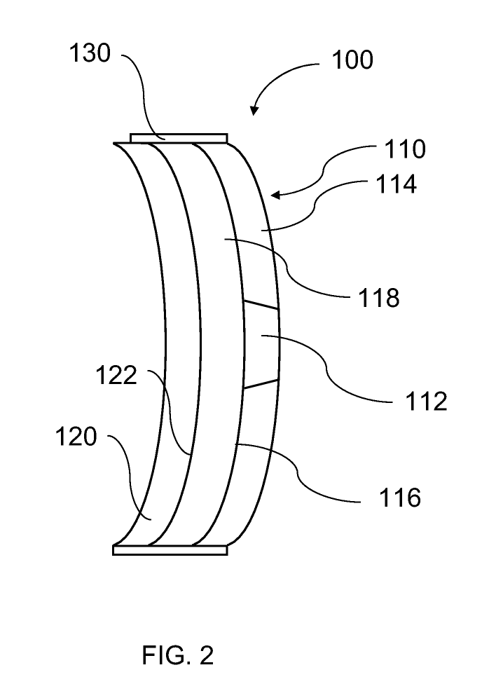

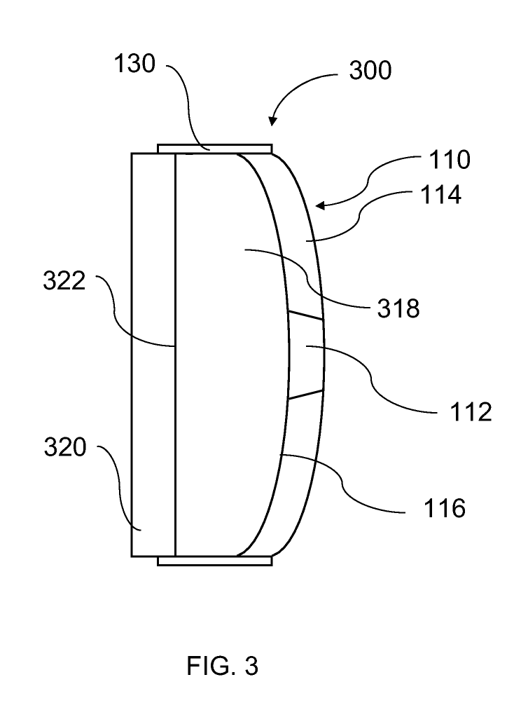

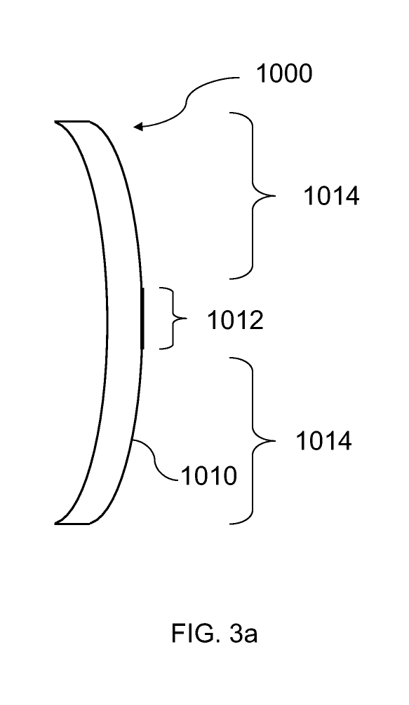

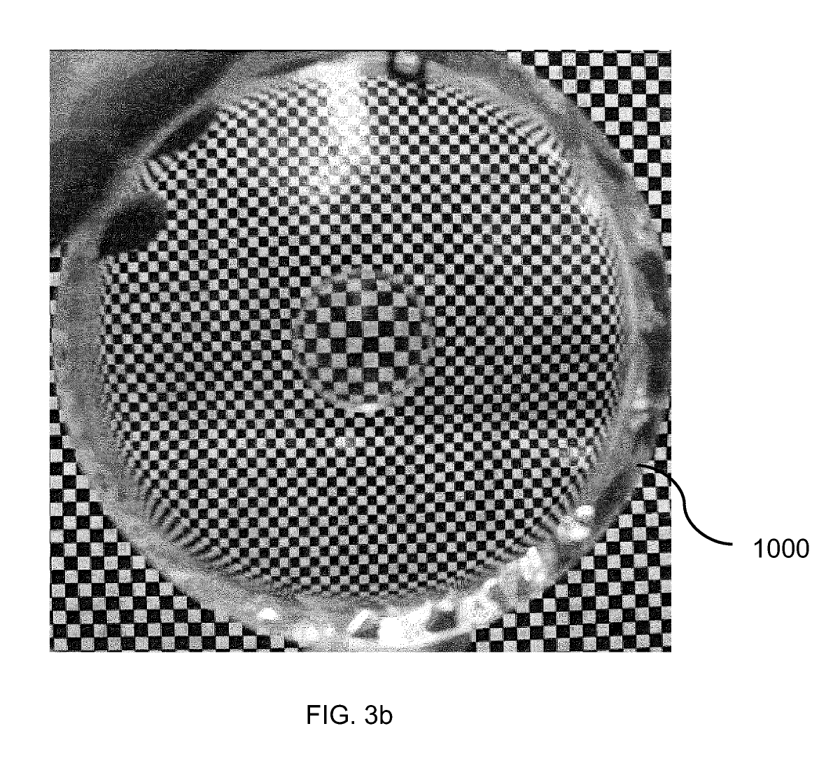

FIG. 2 depicts a cross-sectional view taken through the longitudinal axis of the apparatus 100. As may be seen, front mold 110 includes a surface 116 that is concave relative to the inside of the apparatus 100, and back mold 120 includes a surface 122 that is convex relative to the inside of the apparatus 100. These surfaces form a space 118 into which the pre-solidified plastic lens material is located. It is noted that in other embodiments, the surface of the back mold facing the inside of the apparatus may be flat or convex, as may be seen in apparatus 300 depicted in FIG. 3, where surface 322 of back mold 320 is flat. Thus, space 318 into which the pre-solidified plastic lens material is inserted is bounded by a flat surface at the back and a concave surface at the front. It is further noted that the surfaces of the front mold and the back mold facing the outside of the mold may also be shaped differently. In an exemplary embodiment, these surfaces may also be flat. Any shaped surface of the front and back molds may be used if such surface permits embodiments detailed herein and variations thereof to be practiced.

As may be seen in FIGS. 1-3, the front mold 110 may comprise two portions. Specifically, front mold includes a first mold portion 112 and a second mold portion 114. In an exemplary embodiment, the front mold 110 may comprise more than two portions. In the embodiments depicted in FIGS. 1-3, these portions are separate mold components, although as detailed below, in other embodiments, a monolithic mold component may include these two portions. In an exemplary embodiment, the separate components may be designed to mate together to form the entirety of the front mold. As will be described further below, the first mold portion 112 may be inserted into the second mold portion 114 such that the two are held together via an interference fit. Put another way, a component 114 of the mold 110 can form a bulk portion/component of the mold 110, and a component 112 can form a sub-portion 112 of the mold 110 and can be designed to mate with the bulk portion/component 114. In an exemplary embodiment, as may be seen in FIGS. 1-3, the component 112 can be an insert designed to be inserted or plugged into the component 112.

In an exemplary embodiment, the first mold portion 112 and the second mold portion 114 are arrayed relative to one another and/or are configured such that there is little to no significantly visually and/or visually recognizable identifiable seam/boundary on the resulting lens made with the mold 110 other than the imparted diffractive optical pattern. By way of example, if a surface of the first mold portion 112 was sufficiently proud of the second mold portion 114 and/or visa-versa, a significantly visually and/or visually recognizable identifiable seam/boundary may result on the lens made with the mold 110 beyond that due to the imparted diffractive optical pattern relative to the remaining portions of the resulting lens. An embodiment of the mold 110 is configured/the first and second portions are configured/arranged to avoid the presence of such a significantly visually and/or visually recognizable identifiable seam/boundary. By visually recognizable identifiable seam/boundary, it is meant a seam/boundary that one or more of the fifth percentile female, the fifth percentile male, the fifth percentile female, fiftieth percentile female, the fiftieth percentile male, the ninety-fifth percentile female and/or the ninety-fifth percentile male would be able to identify during normal use of a pair of glasses made from a lens resulting from the mold 110.

Collectively, the surfaces of the first mold portion 112 and the second mold portion 114 facing the interior of the mold form surface 116. The surface of the first mold portion 112 includes a pattern formed thereon that is configured to impart a diffractive optical pattern on a surface of the resulting diffractive ophthalmic lens molded using apparatus 100. That is, the first mold portion 112 includes a negative diffractive optical pattern. Put another way, the component 112 can be used to define specialized features of a surface of the resulting diffractive ophthalmic lens, such as, by way of the just-mentioned example, defining a diffractive optical pattern, and the component 114 can be used to define less distinctive features of the surface of the resulting diffractive ophthalmic lens, such as, by way of the just-mentioned example, one or more refractive features of the surface of the resulting diffractive ophthalmic lens.

In the exemplary embodiment of FIGS. 1-3, surface 116 is the surface that forms the front surface of the diffractive ophthalmic lens produced using the apparatuses detailed herein. Thus, in an embodiment, the front mold can be comprised of two or more components (112 and 114) that together can be used to define a surface of a lens. In this regard, front mold 110 is used to mold one side of the resulting diffractive ophthalmic lens (the front side).

In the exemplary embodiment of FIGS. 1-3, the surface of the second portion 114 facing the interior of the mold includes (e.g., is) a surface that is configured to impart a non-diffractive optical feature on one side of the diffractive ophthalmic lens molded using apparatus 100. In an exemplary embodiment, the non-diffractive optical feature is a feature that imparts refractive properties on the resulting diffractive ophthalmic lens (e.g., a refractive optical surface). FIG. 3a depicts a cross-sectional view of an exemplary resulting diffractive ophthalmic lens 1000 produced by apparatus 100, having a concave surface 1010 with a diffractive region 1012 and a refractive region 1014. FIG. 3b depicts a photograph of an exemplary resulting diffractive ophthalmic lens 1000 also depicting exemplary performance and fidelity capability of the resulting lens. In an exemplary embodiment, the molds detailed herein and variations thereof are configured to obtain a diffractive ophthalmic lens having the performance capabilities vis-à-vis fidelity, magnification, clarity, etc., according to at least that depicted in FIG. 3b.

It is noted that while the embodiment of FIGS. 1-3 has been described in terms of the front mold 110 having the two or more portions detailed herein, in other embodiments, it may be the back mold 120 and/or both molds that have the two or more portions. Alternatively or in addition to this, while the front mold 110 has been described in terms of its relative location to the resulting diffractive ophthalmic lens relative to the eye of a human using the resulting diffractive ophthalmic lens, in some embodiments, the front mold 110 may be used to form the back surface of the resulting diffractive ophthalmic lens, and/or the back mold 120 may be used to form the front surface of the resulting diffractive ophthalmic lens.

In an exemplary embodiment, the two (or more) portions of the front mold 110 may be made of the same material or from different materials. When formed of different materials, the front mold of the present invention can be considered to be a hybrid mold and/or a non-homogeneous mold. In an exemplary embodiment, the second portion/second component 114 of mold 110 may be made of glass and/or plastic and may define the bulk or less specialized features of the resulting diffractive ophthalmic lens 1000 made by apparatus 100 (e.g., the non-diffractive region 1014 of the resulting lens 1000). The first portion/component 112 of the front mold 110 may be made of plastic and can define the more specialized features of the resulting diffractive ophthalmic lens 1000 (e.g., the diffractive region 1012 of the lens). By way of example, apparatus 100 may permit the molding/casting of an ophthalmic lens having a diffractive element in that the apparatus 100 includes a glass back mold and a hybrid glass/plastic front mold. The hybrid glass/plastic front mold may be a glass mold having a plastic insert at the desired location of the diffractive element. The plastic insert may have a negative pattern of the diffractive element of the desired ophthalmic lens. The plastic insert may be produced via plastic injection molding as detailed below or by embossing and may be designed for single use and may be relatively inexpensive.

As used herein, the term “plastic,” when referenced to material from which the molds detailed herein and variations thereof, include thermoplastic materials, thermosetting materials and silicon resin materials. Accordingly, in an exemplary embodiment, the front mold and/or the back mold may be made from PEEK. As will be inferred from the above, in some embodiments, the components of the front and/or back mold may be comprised of any suitable material. Accordingly, the front mold 110 and/or the back mold 120 may comprise silicon. Such exemplary thermoplastic materials may include, but are not limited to polycarbonate, polyamide, PMMA, polysulfone, polyimide, PEEK and modifications thereof that will permit some or all embodiments and variations thereof to be practiced. Some exemplary thermoplastic materials may include, but are not limited to polyallyl carbonate, phenolic resins, cross linked olefinic materials, and polyesters.

In the exemplary embodiment of FIGS. 1-3, the first and second portions 112 and 114 of front mold 110 are collectively configured to mold an entire one side of the ophthalmic diffractive lens 1000, thereby defining a surface 1010 of the lens 1000 having both diffractive optical properties and refractive optical properties at locations on the lens surface 1010 immediately adjacent to the first and second portions 112 and 114, respectively. In an exemplary embodiment, the second portion 114 of front mold 110 is further configured to impart another non-diffractive optical feature different from the refractive optical surface just mentioned on the surface 1010 of the diffractive ophthalmic lens 1000 molded using the front mold 110.

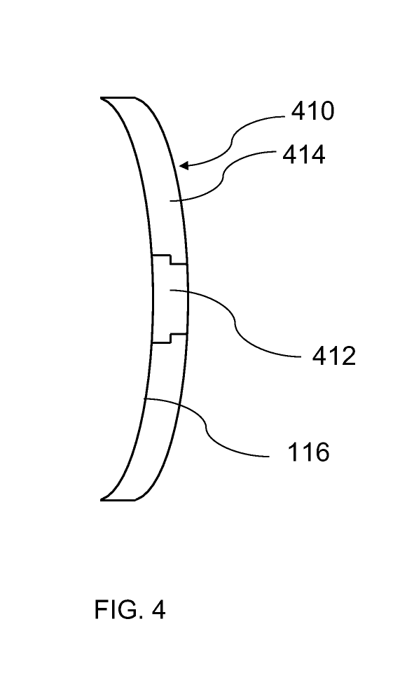

As noted above, the first portion 112 may be connected to and held to the second portion 114 via an interference fit. That is, the first portion 112 and/or the second portion 114 may be made of a material that deforms such that, in the exemplary embodiment where the first portion 112 corresponds to a male portion and the second portion 114 corresponds to a female portion (such that the first portion and the second portion are located relative to one another in a male-female relationship as depicted in FIGS. 1-3), one or both of the portions deforms plastically and/or elastically such that pressure applied to the mating surfaces retains the two portions together. In an alternative embodiment, separate from or in addition to this, the first portion 112 may be connected to the second portion 114 via positive retention. In an exemplary embodiment, a screw or bolt may penetrate through a portion of the second portion 114 at an oblique angle into the first portion 112, but not penetrating past the interior surface 116 of the front mold 110, such that the screw or bolt positively retains the two such that the screw or bolt experiences a shear stress if the two portions are moved away from each other. In an alternate embodiment, separate from or in addition to these embodiments and variations thereof, the first portion 112 may be connected to the second portion 114 via an adhesive bond. Accordingly, the components of the front mold 110 may be mated together in a variety of ways. In a further example, referring to FIG. 4, there is a front mold 410 comprising a first portion/component 412 having some or all of the properties of first portion/component 112 detailed herein, that is in the form of a plug 412 that is fitted into a hole in the second portion/component 414 having some or all of the properties of the second portion/component 112 detailed herein. As may be seen, in contrast to the uniformly tapered outer profile of portion/component 112 of FIGS. 2-3 (which may, in some embodiments, also be considered a plug 112), the plug 412 has an outer-profile that is stepped. One or more of the manners of adhering or otherwise maintaining the connection between the first and second portions may be utilized at one or both of the side-walls forming the stepped configuration of plug 412. It is noted that the hole in the second portion 414 may also be stepped, or may have a smooth contour. As will be recognized, other forms of adhering the first and second portions may be used.

It is noted that the first portion/component 112 may be separated from the second portion/component 114. As will be detailed below, such a feature has utility in that the second portion may be reused and the first portion, which may be more difficult to clean after use, may be disposed of (including recycled) and/or replaced by a new first portion.

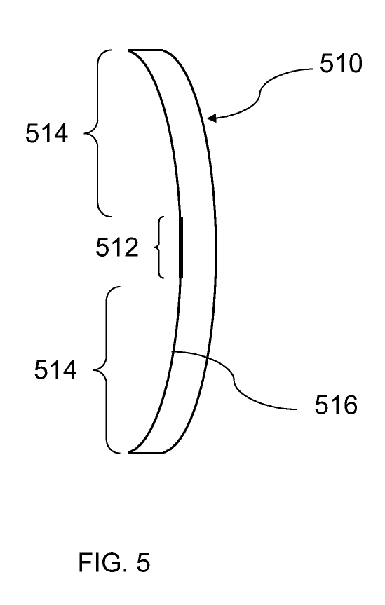

While the first and second portions 112 and 114 have been described above in terms of separate components (i.e., the front mold 110 makes up two or more separate components), some embodiments of the present invention include a front mold that is a monolithic component and the first and second portions are part of that monolithic component. Such an embodiment is encompassed by a first mold that has a portion of the first mold of which the first and second portions and are a part is a monolithic component (e.g., some embodiments include a front mold that is entirely monolithic, and other embodiments include a front mold made of two or more components, but the component that encompasses the first and second portions is monolithic). In this regard, FIG. 5 depicts an alternate embodiment of a front mold in which the front mold is a monolithic component. Specifically, FIG. 5 depicts a front mold 510, that may be used in place of front mold 110 in apparatus 100 detailed herein, that includes a surface 516 comprising first and second regions 512 and 514. These regions 512 and 514 are formed on surface 516. The second region 514 corresponds to the surface of the second portion 114 that makes up surface 116 with respect to FIGS. 2 and 3 above, and the first region 512 corresponds to the surface of the first portion 112 that makes up surface 116 with respect to FIGS. 2 and 3 above. However, instead of these regions being established by separate components of the front lens, they are established by the same component of the front lens. As will be described in greater detail below, front mold 510 may be made by injection molding a thermoplastic material into a mold assembly having a surface (i) that includes features that will permit the corresponding surface of the resulting front mold to have the pattern of the front mold (e.g., at region 514) that is configured to impart the diffractive optical pattern on the surface of the resulting diffractive ophthalmic lens, and (ii) that includes features that will permit the corresponding surface of the resulting front mold to be configured to impart the non-diffractive optical pattern on the surface of the resulting diffractive ophthalmic lens.

In view of the above, in an exemplary embodiment the front mold may be comprised of a single component that can be used to define a surface of a diffractive ophthalmic lens. That is, the mold may be formed of a single piece of material that may be used a single time or a limited number of times to define a surface of a diffractive ophthalmic lens (e.g., a lens having a diffractive region). In an exemplary embodiment, some or all of the features detailed herein with respect to the monolithic embodiments and variations thereof are applicable to some or all of the multi-component embodiments and variations thereof, and visa-versa.

An embodiment of the front mold 110 having first and second portions 112 and 114 and/or a mold 510 having first and second regions 512 and 514 may be considered to have respective working surfaces of the first and second portions/regions configured to impart respective optical features (e.g., diffractive optical features with respect to the first portion 112, refractive optical features with respect to the second portion 114) on one side of the resulting diffractive ophthalmic lens molded using the front mold 110. In an exemplary embodiment, the working surfaces correspond to the portions of surface 116 formed by the first and second portions 112 and 114/first and second regions 512 and 514. Superimposing the regions depicted in FIG. 5 onto FIGS. 2 and 3, in an exemplary embodiment, the region 514 corresponds to the surface of the second portion 114 that makes up surface 116 with respect to FIGS. 2 and 3 above, and the region 512 corresponds to the surface of the first portion 112 that makes up surface 116 with respect to FIGS. 2 and 3 above In an exemplary embodiment, the surface of the first and second portions encompassed by these regions may correspond to the just-mentioned working surfaces. While the figures are not drawn to scale with respect to some embodiments, and the figures denote front and back molds having a circular axial outer circumference, it can be seen that in some embodiments, the working surface of the second portion 114/second region 514 has a relatively larger surface area of the working surface of the first portion 112/first region 512. In some embodiments, the working surface of the second portion 114/second region 514 has at least about five times, and/or at least about 10 times and/or at least about 15 times the surface area of the working surface of the first portion 112/second region 514. According to an exemplary embodiment, a front mold may be made at low cost and may be considered disposable. The negative diffractive optical pattern formed on the front mold/the first portion/first region may be of any size or shape and may be positioned anywhere on the mold as will be further detailed below.

In an exemplary embodiment, a 20.125 mm hole may be machined through the center of an 83 mm diameter glass mold to obtain portion 114. Plastic inserts 112 may be formed (molded, machined, etc.) from different materials and may have diameters ranging from 20.125 to 20.15 mm. In an exemplary embodiment, plastic inserts may be formed with a diameter of 20.13 to 20.14 mm. In an exemplary embodiment, the dimensions and the stiffness of the components are such that at least the fifth percentile female, fiftieth percentile female, ninety-fifth percentile female, fifth percentile male, fiftieth percentile male, and/or ninety-fifth percentile male may place the plastic insert 112 into the glass mold 114 by hand. In an exemplary embodiment, the plastic insert may be made from ZEONEX and may include a negative diffractive optical pattern.

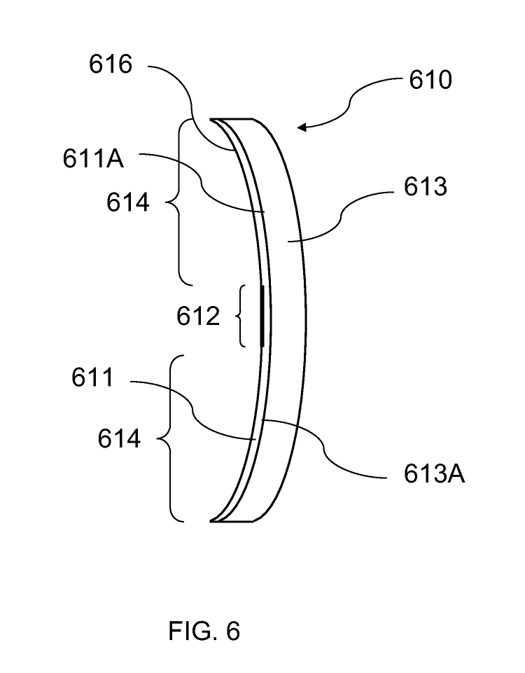

In an exemplary embodiment, the first mold is a layered mold. Referring to FIG. 6, there is an exemplary front mold 610 that may be substituted for the first mold 110 of apparatus 100. The front mold 610 includes a first portion 611 and a second portion 613. As may be seen in FIG. 6, the first portion 611 is a separate component from the second portion 613. In the embodiment of FIG. 6, the second portion 613 is a substrate that supports the first portion 611 and the first portion 611 is a liner lining a surface 613A of the second portion 613. First portion 611 may be fit over or on second portion 613. In the exemplary embodiment of FIG. 6, the first portion 611 is somewhat analogous to first mold 510 detailed above with FIG. 5 in that the first portion 611 is a monolithic component comprising first and second regions 612 and 614. (In other embodiments, the first portion 611 may be made of two or more components that respectively establish the first and second regions 612 and 614 in an analogous manner to the establishment of such regions with respect to front mold 110.) These regions 612 and 614 are formed on surface 616. The second region 614 corresponds to the surface of the second portion 114 that makes up surface 116 with respect to FIGS. 2 and 3 above, and the first region 612 corresponds to the surface of the first portion 112 that makes up surface 116 with respect to FIGS. 2 and 3 above (although, as just detailed, instead of these regions being established by separate components of the front lens, they are established by the same component of the front lens). While the embodiment depicted in FIG. 6 depicts the first portion as the portion that forms the entire front of the resulting ophthalmic diffraction lens, in an alternate embodiment, the front lens further includes a third portion. This portion may be configured to impart a non-diffractive optical feature on one side of the ophthalmic diffractive lens molded using the first mold. As noted above, an exemplary embodiment includes a liner 611 made from two or more components. In such an exemplary embodiment, the first portion and the third portion comprise the liner lining the surface 613A of the second portion 613.

The second portion 613 may be made of glass and/or metal and/or plastic, and the first portion 611 and/or liner of the front mold 610, which may be made of plastic, has surface 611A that adheres to surface 613A of second portion 613. The first portion 611/liner may be adhered to the second portion 611 via an adhesive.

In view of the above, an exemplary front mold may comprise a liner that may define a surface of an ophthalmic diffraction lens. The exemplary liner may be formed that may adhere to a glass or metal substrate. The liner may be used a single time or a limited number of times to cast a lens having desired optical properties. The liner can then be disposed of after a number of uses and replaced with a new liner that can adhere to the same glass or metal substrate, as will be detailed further below. According to an exemplary embodiment, the front mold may be formed by forming a mold component having an adhesive backing that can adhere to substrate or other component of the front mold.

In an exemplary embodiment, referring to front mold 710, which may be substituted for front mold 110 of apparatus 100, the second portion/component 714 may have a slight recess or a bore 715 into which or otherwise where the first portion/component 712 may be positioned. That is, instead of a through hole through which the first portion/component 712 is fitted (as is the case with the corresponding components of front mold 110), a recess or bore 715 that does not pass through the second portion/component 714 is located in that portion/component. Together, the first and second portions/components may define a surface of a lens. In an exemplary embodiment, a pin hole or a push hole (not shown) may be located in the second portion/component 714 aligned with the bore 715 or recess to allow a pin or dowel to be placed into the hole and pass through the hole and into the bore to permit the pin or dowel to be used to push the first portion/component 712 out of the bore 715 to permit the first portion/component 712 to be more readily removed from the second portion/component 714. It is noted that in an alternate embodiment, referring to the front mold 610 of FIG. 6, is configured such that a slight recess is located in the second component 613 into which the first component 611 may be fitted.

As noted above, the embodiments of the front mold detailed herein and variations thereof are applicable, in some embodiments, to the back mold. Thus, some or all of the teachings pertaining to the front mold and variations thereof may be applicable for use to form the front and or the back surface of a ophthalmic diffractive lens.

While the first portion/component that includes the negative diffractive optical pattern is depicted as being located at or approximately at the radial center of the first lens, in other embodiments, the first portion/component may be located in other locations. The front mold may be designed such that the first portion/component may be located or adhered or otherwise mated with the second portion/component at any desired location of the first mold that will permit embodiments to be practiced and variations thereof.

In an exemplary embodiment, there is a method of molding multiple diffractive ophthalmic lenses utilizing an apparatus in which some or all components of the mold used to form the non-diffractive portions of the molded lenses are reused and some components of the mold used to form the diffractive portions of the molded lenses are replaced after each individual lens is molded. In an exemplary method, the front mold, which is entirely made of plastic, is replaced with a new front mold, and the back mold, which may be made of glass, etc., is reused to make another lens. In an alternative method, all of the components of the mold used to form the resulting lenses are discarded after each individual lens is molded, such as in the case where the front mold and the back mold are both formed by plastic.

Some exemplary methods as detailed herein permit the costs of at least the front mold and/or at least the first portion of the front mold to be significantly reduced from prior art molds. Such as exemplary utility in that a lens manufacturer may dispense with cleaning the first portion between molding operations or multiple molding operations. In this regard, the portion that includes the pattern used to impart a diffractive optical pattern on a surface may become fouled by residual material used to make the lens. It is somewhat difficult to clean these portions for their next use (this is the case with both plastic, metal and glass molds). Because it is less expensive to manufacture a component having the desired pattern from plastic (both with respect to material costs and imparting the pattern thereon (injection molding is relatively inexpensive vs. the methods used to form the pattern in a glass mold or an electro-formed nickel/metal mold), exemplary embodiments render it economical to simply utilize the component a limited number of times (one or, in some embodiments, at most, two times), and subsequently dispose of the component. Also, because of the lowered expense, a lens manufacturer may purchase more mold apparatuses. In this regard, at least some lens manufacturers experience a production bottle-neck due to the number of molds available. Indeed, it may take two to three days or more to make a single lens using a single mold. If the cost of the mold can be reduced, the manufacturer can obtain more molds. In an exemplary embodiment, this permits the manufacturer to alleviate the aforementioned bottle-neck, limiting production to, for example, the capacity of the ovens and/or other curing devices available to the manufacturer.

An exemplary method of utilizing the apparatus 100 and variations thereof will now be described. More specifically, a method of molding an ophthalmic diffractive lenses, comprises action “A” which entails obtaining mold corresponding to apparatus 100 (hereinafter, mold 100). As will be recognized from the above, the mold 100 includes at least a first portion 112 that includes a first pattern on a surface thereof, where this first pattern is a negative diffractive optical pattern. The mold 100 also includes at least a second portion 114 that including a surface that, in part, forms surface 116. The exemplary method further includes an action “B,” which entails molding one or more first diffractive ophthalmic lenses 1000 using the obtained mold 100. Action “B,” includes imparting a diffractive optical pattern on a surface 1010 of the first molded diffractive ophthalmic lens 1000 from the pattern on the first portion 112.

The exemplary method further includes action “C,” which entails removing the first portion 112 from the second portion 114. The removed first portion 112 may be disposed of or otherwise recycled. In an exemplary embodiment, action “C” is executed to make only about 10 or less first diffractive ophthalmic lenses 1000. In an exemplary embodiment, action “C” is executed to make only one first diffractive ophthalmic lenses 1000. Following action “C,” action “D” is executed, which entails installing a third portion 112 to the second portion 114 in a location corresponding to the previous position of the first portion 112, wherein the third portion 112 includes a second pattern on a surface 116 thereof. It is noted that in an exemplary embodiment, the method proceeds to action “D,” after action “C” is executed to make only about 10 or less first diffractive ophthalmic lenses 1000, or, on other embodiments, after action “C” is executed to make only one first diffractive ophthalmic lens 1000. It is noted that this second pattern may be a negative diffractive optical pattern. The exemplary method further includes action “E,” which entails molding one or more second diffractive ophthalmic lenses 116 using the mold 100 as modified in action “D.” action

In accordance with the just-described method, the second portion 114 is re-used for multiple ophthalmic diffractive lens casting/molding processes while the first portion 112 is used a limited number of times (e.g., used once and discarded and replaced with a third portion 112 that may be identical in form to the first portion). Accordingly, in some embodiments where the first portion is used to mold one lens, after which the method proceeds from action “B” to action “C,” any need to clean the first portion between moldings/castings (i.e., actions “B” and “E”) can be obviated. Further, in embodiments where the first portion 112 comprises a material that can be used to produce high fidelity diffractive patterns at low cost and is low cost, then the mold 100 of the present invention may significantly reduce the costs associated with fabricating diffractive ophthalmic lenses in comparison to using electroformed nickel molds.

In an exemplary embodiment, the exemplary method further entails molding/casting only about ten or less or only one second diffractive ophthalmic lenses 1000 during action “E,” and after executing action “E,” executing an action “F” which entails removing the third portion 112 from the second portion 114. Following action “F,”, the method includes an action “G,” which entails installing a first portion 112 to the second portion 114 in a location corresponding to the previous position of the third portion 112, wherein the first portion 112 installed in this action is a different component from that of the first portion 112 of action “B.” Following this action, the method further includes action “H,” which includes molding/casting one or more first diffractive ophthalmic lens 1000 using the mold 100, wherein the action of molding the first diffractive ophthalmic lens 1000 includes imparting a diffractive optical pattern on a surface 1010 of the first molded diffractive ophthalmic lens 1000 from the pattern on the first portion 112. The exemplary method further includes action “I,” which entails, after executing action “H,” executing actions “C,” “D” and “E” followed by executing actions “F,” “G,” and “H,” wherein the third portion 112 installed in action “D” is a different component from that of the first portion installed in this action. In an exemplary embodiment, action “I” may be repeated 2, 3, 4, 5, 6, 7, 8, 9 and/or 10 or more times. In an exemplary embodiment, the second portion is the same component used in all of the aforementioned actions.

In an exemplary embodiment, the method just detailed frees the lens manufacturer from having to clean the replaced components between moldings. In the exemplary method detailed above, there is no action of cleaning the first portion 112 that is performed between molding individual first diffractive ophthalmic lenses 1000 during action “B” and between molding individual second diffractive ophthalmic lenses 1000 during action “E.”

An exemplary embodiment of manufacturing the front mold 510 detailed herein will now be described. It is noted that the following is also applicable to the manufacture of the portion 112 of the front mold, as will be detailed further below. In an exemplary embodiment, the following processes may be adapted to mold other front molds or other molds (back molds), etc., or other portions of the mold.

In an exemplary embodiment, a mold assembly is manufactured or otherwise obtained. The mold includes working surfaces (i.e., surfaces that form the surface of the resulting mold) made of metal or some correspondingly durable and finishable (i.e., capable of having a pattern imparted thereto to adequately apply the pattern to the front mold that is used to impart the diffractive optical pattern on the surface of the resulting mold). These working surfaces form, at least in part, a cavity in the mold apparatus. In an exemplary embodiment, the mold assembly may be made of two-halves of machined metal into which the pattern for the diffractive pattern has been machined or otherwise attached. When these two-halves are brought together, the above-mentioned cavity is formed. In an exemplary embodiment, the mold assembly may be an electro-formed nickel mold. Any mold that will permit the desired fidelity of the diffractive pattern to be imparted to the resulting front mold such that the front mold may be used to impart a diffractive optical pattern on a surface of a resulting lens may be used in some embodiments of manufacturing/producing a mold apparatus to manufacture front molds.

A plastic material may be injected into a cavity formed by the two-halves of the mold apparatus. Once the plastic material hardens, the now-hardened material is extracted from the mold apparatus. This now-hardened material is in the form of a front lens according to the embodiments herein and variations thereof, although in other embodiments, additional processing steps may be applied. The front mold 510 is placed in proximity to an acquired back mold 120 which may be made of glass, metal and/or plastic, etc. A tape or gasket 130 is applied to the outer perimeters of the two molds to form assembly 100. It is noted that the contouring of the portion 112/hole in portion 114 may be the opposite of that depicted in FIG. 2 (e.g., the cone widens from left to right). Such tape may be applied utilizing, for example, a tape machine.

In an exemplary embodiment, the front mold may be formed by thermoforming, injection molding and/or hot embossing such that a surface of the front mold has pattern that will permit the impartation of the diffractive optical pattern onto a diffractive lens.

In an exemplary embodiment, the front mold may be formed such that a first surface has a desired optical feature of a final lens (e.g., a diffractive pattern) and a second surface has the ability to adhere to a separate surface.

The just-described manufacturing process may be modified to manufacture the first portion/component 112 detailed above and variations thereof. In an exemplary embodiment, the just-described manufacturing process is executed to obtain a first portion/component 112 made of plastic. This first portion/component is inserted into a second portion/component 114 made of glass, metal and/or plastic, etc., to form front mold 110. The formed front mold 110 is placed in proximity to an acquired back mold 120 which may be made of glass, metal and/or plastic, etc. A tape or gasket 130 is applied to the outer perimeters of the two molds to form assembly 100.

According to an exemplary embodiment, as may be seen above, the front mold and/or the back mold may be used to mold/cast plastic lenses. The process for industrial production of plastic lenses, especially lenses made of polyurethanes and polythiourethanes, may be difficult. One difficulty in molding polyurethanes is the tendency of these polymers to adhere to glass molds and metal molds. The resin or other material used to make the lenses often has a tendency to adhere even more to plastic molds. Therefore, according to an exemplary embodiment, there is a release agent mixed with the urethane or thiourthane resins used to make the lenses that may limit unwanted adhesion of the resulting lenses to the molds detailed herein and variations thereof. In an exemplary embodiment, higher concentrations of a release agent will be used when using plastic molds as opposed to glass or metal molds so as to facilitate disassembly of the plastic mold/removal of the resulting lens from the front mold.

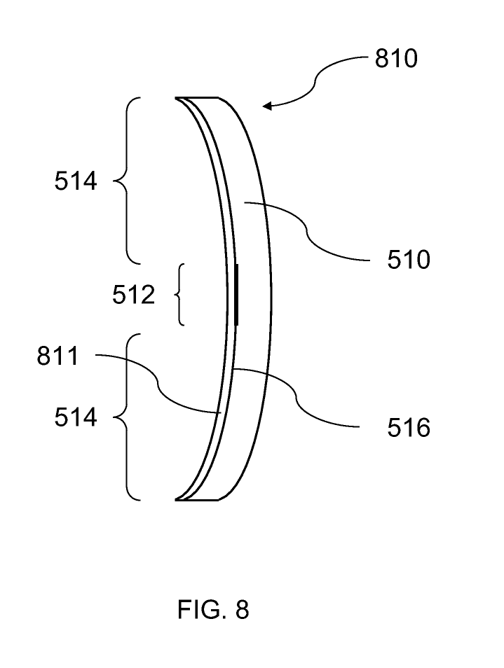

An exemplary embodiment includes a front mold 810 as depicted in FIG. 8. The front mold 810 includes front mold 510 detailed above with respect to FIG. 5. The surface 516 of front mold 510 (which is a plastic surface) is coated with a release layer 811, as may be seen. The release layer 811 comprises surface lubricants such as, but not limited to, siloxanes and fluorinated hydrocarbons. Accordingly, the release layer 811 corresponds to external release agents. These external release agents may be applied by dipping or spinning them on the surface 516 of front mold 510. These external release agents may also be applied as an aerosol or as an air atomized spray. The external release agent can also be applied manually by hand. Any device, system and/or method that will permit the release agents to be applied to a front lens as detailed herein and variations thereof may be practiced in some embodiments.

In an exemplary embodiment, the front mold 110 formed by two or more components (112 and 114) and/or any other front mold detailed herein and variations thereof may replace front mold 510 to obtain front mold 810. That is, layer 811 may be applied to front mold 110 or another mold. In an exemplary embodiment where the first portion is plastic and the second portion is glass, the external release agent may only be applied to the first portion mostly applied to the first portion and/or may be applied in greater relative amounts to the first portion than to the second portion.

In an exemplary embodiment, the nature of the release agent may be varied. For example, the chemical composition, the content of solids and content of solvent, as well as the thickness of release coating, may be varied to alleviate or otherwise at least partially mitigate some drawbacks, which may include having part or all of the layer 811 transferring to the surface of the resulting lens, which can adversely affect the resulting lens surface such that it may result in non-uniform tinting or poor coating adhesion. Further, some problems relating to partial transfer of the layer 811 (release coating) onto the surface of the resulting lens or the cosmetic and optical defects originating from the release agent can be overcome or otherwise at least partially mitigated.

It is noted that in an exemplary embodiment, the layer 811 includes films, coatings, etc. Layer 811 may also include multiple layers, films and coatings, etc., and combinations thereof.

In an exemplary embodiment, layer 811 may be obtained by applying a hydrophobic film through vacuum deposition onto a surface of a mold. In such an exemplary embodiment, this may provide a relatively consistent disassembly process of the plastic mold from the lens when the plastic mold is used to cast urethanes or thiourethanes lenses. In an exemplary embodiment, layer 811 may be obtained by applying one or more thin hydrophobic layers on the surface of the mold. Layer 811 may be obtained via plasma polymerization of fluorinated monomers, as well. In an exemplary embodiment, a continuous plasma polymerization process can be executed at atmospheric pressure yielding a reasonably high production yield of the molds at lower cost. By adjusting the composition of the hydrophobic coating and the parameters of the coating process (e.g., by vacuum deposition or plasma polymerization), the layer/coating surface energy (i.e. contact angle) can be tuned to a desired value or range of values, which may result in improved release of the cured lens product from the mold (which may be disposable).

In another exemplary embodiment, the lens material used for making lens substrates, introduced in the cavity between the disposable mold and the glass mold may be cured via heat or UV light, or in the case of non-transparent molds, e-beam polymerization can be used.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment can be combined with one or more features of any other embodiment without departing from the scope of the invention.

A recitation of “a”, “an” or “the” is intended to mean “one or more” unless specifically indicated to the contrary

What is claimed is:

1. An apparatus for molding at least one side of a diffractive ophthalmic lens, comprising:
a first mold, wherein the first mold includes at least a first portion made of plastic, and wherein the first portion includes a first pattern on a surface thereof, the first pattern configured to impart a diffractive optical pattern on a surface on the at least one side of the diffractive ophthalmic lens molded using the first mold.

2. The apparatus of claim 1, wherein the first mold includes:
a second portion, wherein the first portion is a separate component from the second portion, wherein the second portion includes a surface that is configured to impart a non-diffractive optical feature on the at least the one side of the diffractive ophthalmic lens molded using the first mold.

3. The apparatus of claim 2, wherein the non-diffractive optical feature is a refractive optical surface.

4. The apparatus of claim 2, wherein the first portion and second portion are made of plastic.

5. The apparatus of claim 2, wherein the second portion is made of glass.

6. The apparatus of claim 2, wherein the first portion and the second portions include respective working surfaces configured to impart the respective optical features on the at least the one side of the diffractive ophthalmic lens molded using the first mold, wherein the working surface of the second portion has at least about five times the surface area of the working surface of the first portion.

7. The apparatus of claim 1, wherein:
the first mold is a monolithic component.

8. The apparatus of claim 7, wherein the first mold includes:
a second portion, wherein the first portion and the second portion form at least a portion of the monolithic component, and wherein the second portion includes a surface that is configured to impart a non-diffractive optical feature on the at least the one side of the diffractive ophthalmic lens molded using the first mold.

9. The apparatus of claim 8, wherein the non-diffractive optical feature is a refractive optical surface.

10. The apparatus of claim 1, wherein the first portion is made of plastic.

11. The apparatus of claim 1, wherein:
the first mold includes a second portion;
wherein the first portion is a separate component from the second portion;
wherein the second portion is a substrate that supports the first portion; and
wherein the first portion is at least part of a liner lining a surface of the second portion.

12. The apparatus of claim 11, wherein the second portion is made of glass and/or metal, and wherein the first portion adheres to the second portion.

13. The apparatus of claim 11, wherein:
the first mold includes a third portion, wherein the third portion is configured to impart a non-diffractive optical feature on the at least the one side of the diffractive ophthalmic lens molded using the first mold, wherein the liner comprises the first portion and the third portion.

14. The apparatus of claim 11, wherein the first portion is adhered to the second portion via an adhesive.

15. The apparatus of claim 1, wherein the first portion includes a layer of release agent.

16. An apparatus for molding at least one side of a diffractive ophthalmic lens, comprising:
a first mold, wherein the first mold includes:
at least a first portion that includes a first pattern on a surface thereof, the first pattern configured to impart a diffractive optical pattern on a surface of the at lest one side of the diffractive ophthalmic lens molded using the first mold; and
a second portion, wherein the first portion is a separate component from the second portion, wherein the second portion includes a surface that is configured to impart a non-diffractive optical feature on the at least one side of the diffractive ophthalmic lens molded using the first mold.

17. The apparatus of claim 16, wherein the first portion is separable from the second portion.

18. The apparatus of claim 16, wherein the first portion is connected to and held to the second portion via an interference fit.

19. The apparatus of claim 16, wherein the first portion is connected to the second portion via positive retention.

20. The apparatus of claim 16, wherein the first portion is connected to the second portion via an adhesive bond.

21. The apparatus of claim 16, wherein the first portion corresponds to a male portion, and the second portion corresponds to a female portion, and wherein the first portion and the second portion are located relative to one another in a male-female relationship.

22. The apparatus of claim 16, wherein the non-diffractive optical feature is a refractive optical surface, and wherein the first and second portions are collectively configured to mold the entire at least one side of the diffractive ophthalmic lens, thereby defining a surface of the lens having both diffractive optical properties and refractive optical properties at locations on the lens surface immediately adjacent to the first and second portions, respectively.

23. The apparatus of claim 22, wherein the second portion is further configured to impart another non-diffractive optical feature different from the refractive optical surface on the at least the one side of the diffractive ophthalmic lens molded using the first mold.

24. The apparatus of claim 16, wherein the first portion includes a layer of release agent.

25. A method of molding an ophthalmic diffractive lenses, comprising:
(a) obtaining a mold apparatus, wherein the mold apparatus includes:
at least a first portion that includes a first pattern on a surface thereof; and
(b) molding at least one first ophthalmic diffractive lenses using the obtained mold apparatus, wherein the action of molding the first diffractive ophthalmic lens includes:
imparting a diffractive optical pattern on a surface of the first molded ophthalmic diffractive lens from the pattern on the first portion;
(c) removing the first portion from the mold apparatus;
(d) installing a second portion to the mold apparatus in a location corresponding to a previous position of the first portion, wherein the second portion includes a second pattern on a surface thereof; and
(e) molding one or more second ophthalmic diffractive lenses using the obtained mold apparatus as modified with the second portion, wherein the action of molding the second ophthalmic diffractive lens includes:
imparting a diffractive optical pattern on a surface of the second molded ophthalmic diffractive lens from the pattern on the second portion.

26. The method of claim 25, further comprising:
molding only about 10 or less first ophthalmic diffractive lenses before proceeding from action “c” to action “d”.

27. The method of claim 25, further comprising:
molding only 1 first ophthalmic diffractive lens before proceeding from action “c” to action “d”.

28. The method of claim 26, further comprising:
molding only about 10 or less second ophthalmic diffractive lenses during action “e”; and
after completing action “e”:
(f) removing the second portion from the mold;
(g) installing a first portion on the mold in a location corresponding to a previous position of the second portion, wherein the first portion installed in action “g” is a different component from that of the first portion of action “a” and
(h) molding one or more first ophthalmic diffractive lens using the mold apparatus as modified in action “g,” wherein one or more first ophthalmic diffractive lenses are different from those molded in action “b,” wherein the action of molding the first ophthalmic diffractive lens includes:
imparting a diffractive optical pattern on a surface of the first molded ophthalmic diffractive lens from the pattern on the first portion.

29. The method of claim 28, further comprising:
(i) after executing action “h,” executing actions “c,” “d” and “e” followed by executing actions “f,” “g,” and “h,” wherein the second portion installed in action “d” is a different component from that of the second portion installed in action “i,”; and
(j) repeating action “i” five times.

30. The method of claim 29, wherein:
the mold apparatus includes a mold that has a portion that is the same portion used to mold a surface of the lenses molded in actions “a” to “j”.

31. The method of claim 25, wherein no action of cleaning the first portion is performed between molding individual first diffractive ophthalmic lenses during action “b” and between molding individual second diffractive ophthalmic lenses during action “e.”

32. A method of manufacturing an apparatus for molding at least one side of a diffractive ophthalmic lens, comprising:
obtaining a mold assembly including a cavity having a first pattern on a surface thereof;
adding plastic material into the cavity; and
allowing the plastic material to cure such that an outer surface contours to the shape of the surface of the cavity such that a negative of the first pattern is transferred to the cured plastic material, wherein
the cured plastic material is in the form of a front mold or a portion of a front mold, and
wherein the negative of the first pattern on the surface of the cured plastic material is configured to impart a diffractive optical pattern on a surface on the at least one side of the diffractive ophthalmic lens molded using the first mold.

33. The method of claim 32, further comprising:
positioning cured plastic material in the form of a front mold or a portion of a front mold proximate a glass or metal mold; and
attaching the cured plastic material and the glass or metal mold together such that a cavity is formed between the two.

34. The method of claim 32, wherein the action of adding plastic material into the cavity and allowing the plastic material to cure is executed via an injection molding process.

35. The method of claim 32, further comprising:
applying a layer of release agent to the surface of the cured plastic material on which the negative of the first pattern is located.
